(19) United States
(12) Patent Application Publication
(10) Pub. No.: US 2013/0226915 A1
(43) Pub. Date: Aug. 29, 2013

(54) ORGANIZATION OF SEARCH RESULTS BASED UPON AVAILABILITY OF RESPECTIVE PROVIDERS COMPRISED THEREIN

(71) Applicants: Christopher L. Scofield, Seattle, WA (US); William J. Schwebel, Seattle, WA (US); Kevin Foreman, Sammamish, WA (US); Kush G. Parikh, Kirkland, WA (US)

(72) Inventors: Christopher L. Scofield, Seattle, WA (US); William J. Schwebel, Seattle, WA (US); Kevin Foreman, Sammamish, WA (US); Kush G. Parikh, Kirkland, WA (US)

(73) Assignee: INRIX, Inc., Kirkland, WA (US)

(21) Appl. No.: 13/407,841

(22) Filed: Feb. 29, 2012

(51) Int. Cl. G06F 17/30

(52) U.S. Cl. 707/724; 707/E17.018

(57) ABSTRACT

One or more techniques and/or systems are provided for providing search results for presentation as a function of the availability of respective providers comprised in the search results. For example, a user may perform a search for local groceries stores and stores within a 5 miles geographic radius of the user may be identified and filtered/distinguished as a function of the availability of respective stores. Such availability may be a function of whether respective stores are open or closed at the time of the search, whether respective stores are expected to be open or closed at an estimated time of arrival (e.g., based upon travel time from the user's location at the time of the search to respective stores), and/or parking considerations (e.g., parking availability, type of parking, and/or parking cost) at respective stores.

### BACKGROUND

With the advent of location-enabled devices (e.g., smartphones, navigation devices, etc.), applications have been developed that provide services based upon the location of the user. For example, applications have been developed that utilize the user's location to, among other things, offer coupons to nearby stores, assist a user in navigating unfamiliar areas, and/or locate nearby points-of-interest (e.g., shops, restaurants, gas stations, museums, etc.). By way of example, numerous applications have been developed that allow a user to search for nearby coffee shops or other providers (e.g., goods providers or service providers). Generally, such applications utilize entered/selected search terms and information regarding a user's location, to identify a set of providers that are relevant based upon the search terms and the user's location. Some of these applications are also configured to assist a user in navigating to a provider selected from the set of providers.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, systems and/or techniques are described herein for identifying goods and/or service providers (e.g., hereinafter referred to as providers, local providers, and/or the like) that are temporally and/or geographically proximate to a user and are currently available and/or are expected to be available at a user's estimated time of arrival to respective providers (e.g., given the user's current location and the location of respective providers). The availability of respective providers may be a function of, among other things, store hours and/or parking consideration, for example.

As a basic example, a user may be interested in visiting a coffee shop and may perform a search to identify coffee shops in close temporal and/or geographic proximity to the user (e.g., within a 3 mile radius of the user). If the search is performed at 9:01 pm, the results may distinguish those nearby coffee shops that are still open at 9:01 pm from those that closed at 9:00 or earlier (and are thus unavailable), for example. Similarly, coffee shops that have closed by 9:01 pm may be filtered out of the search results and/or excluded from search results that are provided to the user.

The availability of a provider may also depend upon, among other things, whether the provider is expected to be available/open at a user's estimated time of arrival. By way of example, returning to the search for a nearby coffee shop, results may be further and/or instead distinguished based upon the probability of the coffee shop being open at the user's estimated time of arrival. For example, the closest coffee shop to the user may have a travel time of 10 minutes and may close at 9:05. Thus, while the coffee shop is still open at the time the search is performed, the presented search results may indicate that the closest coffee shop is likely to be closed before the user arrives and/or the closest coffee shop may be excluded from the results provided to the user because the user is unlikely to arrive there before it closes (e.g., and thus becomes unavailable).

Current and/or future traffic considerations may also be taken into consideration when estimating a time of arrival to respective providers that satisfy the search criteria. In this way, the search results that are provided to the user and/or the manner in which the search results are provided (e.g., distinguishing those that are expected to be open at an estimated time of arrival from those that are expected to be closed), factor in real-time information that may influence whether a provider is available at the estimated time of arrival, for example.

Availability of a provider can also and/or instead be a function of parking considerations, for example. Such parking considerations may include, among other things, the availability of parking, type of parking (e.g., onsite parking or street parking), and/or cost of parking. For example, a user may specify filtering criteria (e.g., such as a preference for on-site parking and/or free parking) and/or preferences may be set by default. Providers that satisfy the criteria/preferences may be distinguished from providers that do not and/or providers that do not satisfy the criteria/preferences may be excluded from search results provided to the user, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an exemplary method for providing search results for presentation as a function of whether one or more providers comprised in the search results are available.

FIG. 2 is an illustration of an exemplary scenario where search results may be provided for presentation as a function of an availability of respective providers comprised in the search results.

FIG. 3 is an illustration of example search results.

FIG. 4 is an exemplary method for estimating a time of arrival to respective providers.

FIG. 5 is an exemplary method for providing search results for presentation as a function of whether one or more providers comprised in the search results are available.

FIG. 6 illustrates an example system for providing search results for presentation as a function of whether one or more providers comprised in the search results are available.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

The widespread availability of mobile devices has enabled a large number and variation of techniques and/or services based on such mobile devices. In particular, many devices are equipped to detect a location of the user, such as through the inclusion of a global positioning system (GPS) receiver in a navigation device, a mobile phone, or a tablet, and location-based services and/or techniques enable such devices to mediate the interaction of users with physical locations. For example, navigation devices may store or be configured to retrieve detailed travel maps of a locale, and may use a detected location to display the user's current location or to compute travel routes to intended destinations. Many such techniques and/or services are intended to assist travelers, such as vehicle passengers, bicyclists, and/or pedestrians, through the provision of location-based information. For example, such techniques and/or services may provide a user with information about and/or directions to local shops, restaurants, and/or entertainment venues of interest to a person unfamiliar with a given area.

As one example, numerous applications are available that allow a user to locate a nearest drugstore or other goods/service provider. Typically, such applications function by acquiring location information about the user (or rather about a device being used by the user to perform the search) when the user performs a query/search for drugstores. The query and the location information are used to identify relevant results, which are presented (often in a map) to the user. Generally, these applications further provide for navigating the user to a drugstore selected from the presented results.

While applications of this type are enormously popular, particularly to travelers that are unfamiliar with an area, the information provided by these applications is often incomplete/misleading. This is because such applications often do not take into account the availability of providers listed in the results (e.g., such as whether a provider is presently open or closed). For example, suppose a user performs a search for nearby drugstores at 9:01 pm and the search results display the nearest 15 drugstores. If a user proceeds to walk/drive to the nearest drugstore, s/he may discover that his/her trip is in vain because the drugstore closed at 9:00 pm.

Thus, techniques and/or systems are described herein for providing search results as a function of the availability of providers. For example, if a user performs a search for nearby drugstores at 9:01 pm, the provided search results may distinguish drugstores that are open at 9:01 pm from drugstores that are closed and/or the search results may be filtered such that merely those drugstores that are open at 9:01 pm are presented to the user. Moreover, in one embodiment, drugstores that are expected to be opened at a user's estimated time of arrival (e.g., given the user's location at the time of the search and the location of respective drugstores) may be distinguished from drugstores that are expected to be closed at the user's estimated time of arrival (e.g., even though they may be open at the time of the search). In this way, the user may be better informed when making a decision regarding which drugstore to visit, for example.

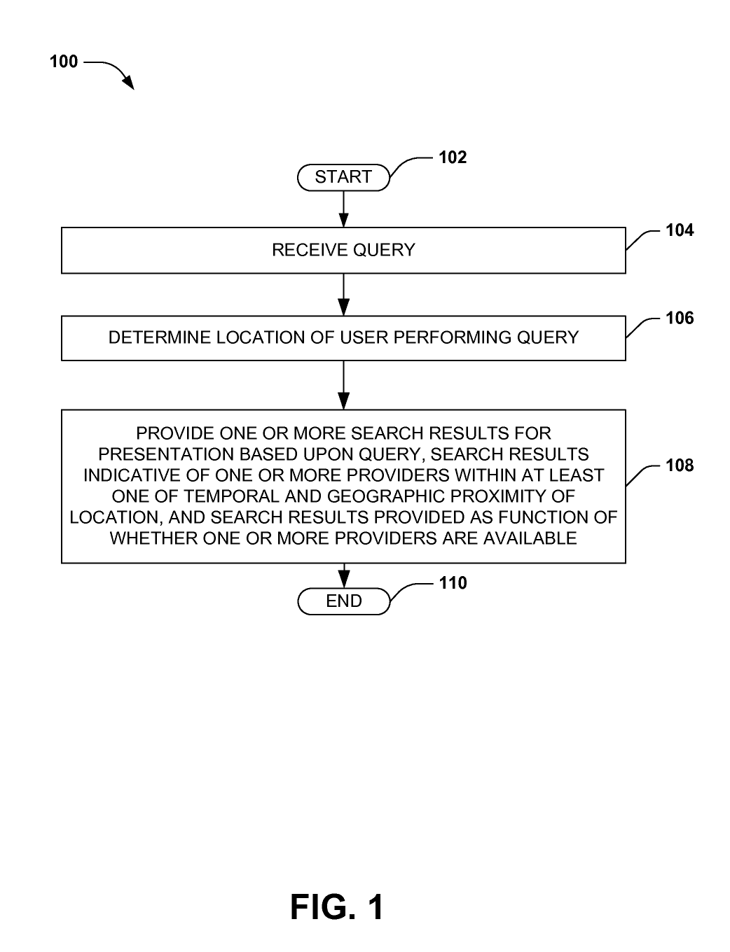

FIG. 1 illustrates an example method 100 for providing a user with information about local providers (e.g., providers within a temporal and/or geographic proximity of the user). More particularly, FIG. 1 illustrates an example method 100 for providing one or more search results for presentation to a user in response to a location-related query. For example, a user may perform a query to identify local providers, such as local goods providers (e.g., shopping outlets, grocery stores, drugstores, etc.) and/or local service providers (e.g., plumbers, accountants, lawyers, etc.), and the example method 100 may be utilized to identify providers satisfying the query.

The example method 100 begins at 102, and a query is received at 104. The query is typically indicative of user entered and/or user selected term(s), although the term(s) may be entered and/or selected without user involvement. For example, in one embodiment, the user may enter a query into a search field of an application configured to provide location-based services. Such an application may be hosted by an operating system of a user's device (e.g., such as a smartphone application hosted by an operating system of a mobile telephone) and/or may be hosted by a remote service accessible to a user via a web browser of the device, for example.

In one embodiment, receiving the query comprises receiving a user entered term(s) and/or a user selected term(s) at an application. By way of example, in one embodiment, an application hosted on a device associated with the user may be substantially fully self-contained. That is, the application may store local maps and/or information about local providers in a storage medium on the device. Thus, when a query is performed, the application may perform a search of the localized database to identify relevant search results. In such an embodiment, information about the search may not be transmitted to other devices external to the user's device.

In another embodiment, receiving the query may comprise, among other things receiving search term(s) (e.g., the query) at a remote computing system (e.g., remote server) configured to process the request and return results to the device associated with the user. That is, storing maps and/or information about local providers may be resource intensive and/or lead to inaccurate results (e.g., unless continuous updates are provided to the device). Thus, the application may be configured to transmit query-related information (e.g., via one or more network interfaces) to a remote computing system, for example, that is configured to receive the information, identify relevant search results based upon the information, and return the results to the device associated with the user. In this way, a centralized computing system (e.g., which may have more resources available and/or may comprise more up-to-date information about local providers) may process the request as opposed to the device associated with the user, for example.

At 106 in the example method 100, a location of the user performing the query is determined. It will be appreciated that the phrase “determining a location of a user,” is intended to be interpreted to include, among other things, determining a location of a device associated with the user. That is, by determining a location of a device that the user is utilizing to perform the search, the location of the user can be indirectly determined. Thus, determining the location of the user may be interpreted broadly to comprise, determining the location of a device associated with the user and/or determining the location of the user, for example.

Those of skill in the art will appreciate that numerous techniques exist that can be employed for determining/approximating the location of a user/device. For example, mobile devices often comprise GPS components that detect signals transmitted from GPS satellites and use the detected signals to determine/approximate a location the user/device. Other electronic devices may comprise adapters configured to identify wireless networks and/or cellular telephone towers. Based upon which networks and/or towers are identified and/or the strength of signals detected from respective networks and/or towers, the location of the user/device can be determined/approximated (e.g., by comparing such information to a database specifying locations of respective networks/towers). It will be appreciated that these techniques are merely example techniques that may be utilized for determining/approximating the location of the user/device and are not intended to be interpreted as limiting the scope of the disclosure, including the scope of the claims. That is, other location determining/approximating techniques may be known to those skilled in the art and are contemplated for use with the techniques/systems described herein.

Moreover, it will be appreciated that where a query is transmitted to a remote computing system, the location information may also be transmitted to the remote computing system in raw and/or synthesized form. That is, the transmitted location information may be information about the detected signals (e.g., which may be processed/synthesized by the remote server to determine the user's location) and/or it may be information about a determined location (e.g., where the user's device may process/synthesize information about the detected signals to determine a location of the user/device prior to the location information being transmitted to the remote computing system).

At 108 in the example method 100, one or more search results are provided for presentation based upon the query. That is, stated differently, based at least in part upon the received query and the determined location of the user, a search may be performed to identify relevant results, and at least some of these results may be provide for presentation to the user. For example, in an embodiment where a remote computing system performs the search, providing one or more search results (e.g., at least some of the identified, relevant results) for presentation may comprise transmitting information indicative of the one or more search results from the remote computing system to the device associated with the user for presentation on the device. In other scenarios where the device itself performs the query, providing one or more search results for presentation may merely comprise providing, to a graphic rendering component, information about how to render the provided one or more search results on the device.

Generally, the search results are, among other things, indicative of one or more providers (e.g., goods providers and/or service providers) within a temporal and/or geographic proximity of the location determined at 106. For example, if a user were to search for post offices, the search results may include the 15 post offices that are nearest the user and/or may include post offices within a 10 mile radius of the determined location. It will be appreciated the phrase “temporal and/or geographic proximity of the location” is not intended to be defined as within a specified radius/range of the location determined at 106 and/or reachable within a specified amount of time. Rather, it is merely intended to describe how the location of the user/device is taken into consideration when identifying relevant search results. For example, the user may search for a company that has a plurality of locations, with the nearest location being 100 miles away, and the search results may display the location that is 100 miles away from the user. Thus, despite the nearest location being 100 miles away, it may be determined to be a relevant search result because it is the nearest location that corresponds with (e.g., matches) the query. In this way, how near or distant the relevant results (from the determined location) may be a function of the query received at 104, for example.

It will also be appreciated that, while not always having a perfect correspondence, there may be some relation between how close a provider is temporally (e.g., how soon a user could arrive at the provider given the user's location) and how close a provider is geographically. For example, those providers that are geographically proximate the user (e.g., within a 5 mile radius of the user) also tend to be more temporally proximate to the user than those located further away from the user (e.g., 20 miles away). Thus, as used herein, geographic proximity and temporal proximity may be used interchangeably to describe the same feature. That is, as used herein, temporal proximity and geographic proximity are simply intended to describe how results are identified/filtered as a function of how close they are to the user, where closeness may be determined based upon geographic and/or temporal proximity, for example.

The search results that are provided for presentation may also be a function of the availability of providers identified in the search results, where the availability of provides may depend upon, among other things, store hours of respective providers and/or parking considerations of respective providers. For example, search results that are relevant to the query and/or are within a temporal and/or geographic proximity of the location determined at 106 may comprise providers (e.g., stores, restaurants, etc.) that are closed and/or that lack adequate parking. Such results may be filtered out of search results provided for presentation and/or may be distinguished, in the provided search results, from stores that are open and/or comprise adequate parking. In this way, a user may be provided with additional information regarding providers that may be relevant in determining which provider(s) to visit, for example.

By way of example, suppose that a search is performed at 6:00 am for a grocery store. The search results may identify 20 grocery stores within a 10 mile radius of the location determined at 106. However, out of these 20, 10 might be closed until at least 6:30 am. Therefore, the search results that are provided for presentation may include merely those 10 grocery stores that are open (and thus available) at 6:00 and/or the provided search results may distinguish the 10 available grocery stores from those that are unavailable (or closed) at 6:00 am.

The results may also and/or instead be provided based upon whether respective stores are expected to be open at an estimated time of arrival (e.g., assuming the user starts to travel to the store shortly after the search). For example, a grocery store that has an estimated travel time of about 30 min from the user's locations and opens at 6:30 am may be listed in the provided search results as available (e.g., even though it may be unavailable/closed at 6:00 am when the search is performed) because it is expected to be open by the time a user arrives at the store. In one embodiment, the estimated time of arrival to respective providers comprised in the search results may also take into consideration current and/or predicted future traffic patterns to improve determinations regarding availability (e.g., as will be described in more detail below).

While the above example describes availability as being a function of whether respective providers identified in the search results are open or close (or are likely to be open/closed at a respective time of arrival), availability may also and/or instead be a function of other considerations, such as parking considerations. For example, search results may be provided for presentation as a function of available parking, type of parking (e.g., on-street, on-site, etc.), and/or cost of parking. By way of example, a grocery store that is open at 6:00 am but merely comprises on-street parking (e.g., which may be occupied by residents who have not yet to left for work) may not be provided in the search results and/or may be distinguished from another grocery store comprised in the results that is open at 6:00 am and comprises on-site parking. In this way, the results may assist the user in locating a provider that is both open and has adequate parking.

Thus, the availability of a provider listed in the search results may be a function of one or more criteria, including, but not limited to store hours and/or store parking. Moreover, it will be appreciated that in one embodiment, the user may determine what criteria are used to determine availability (or filter the results). For example, some users may prefer to filter/distinguish results based merely upon store hours while other users may prefer to filter/distinguish results based upon other availability considerations, such as parking considerations. The user may also specify other details related to availability. For example, the user may specify particular parking considerations of concern and/or may specify whether availability is a function of whether respective providers are open at the time of the search and/or a function of whether respective providers are expected to be open at an estimated time of arrival.

The example method 100 ends at 110.

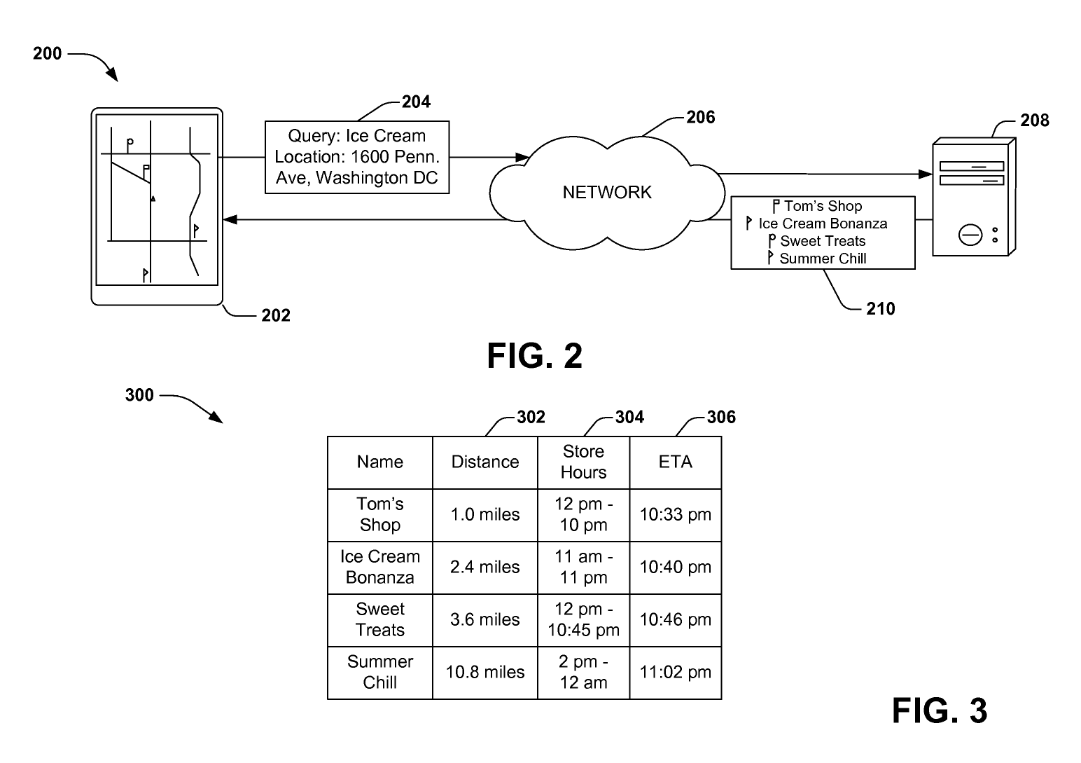

FIG. 2 illustrates an example environment 200 for performing the method 100 of FIG. 1. For purposes of this example, suppose it is 10:30 pm, and a user is interested in getting some ice cream. The user may engage a search application on his/her mobile device 202 and/or other computing system and perform a search for local ice cream shops by entering the phrase “ice cream.” This query 204, along with information about the location of the user/device, may be sent to a remote server 208 configured to process the query and identify nearby ice cream shops via one or more network interfaces 206.

In the illustrated embodiment, the search application that is displayed on the mobile device 202 comprises a map, with the user's location indicated by a triangle. Moreover, as will be described below, the flags comprised on the map respectively represent a local provider that has been identified based upon the query. Thus, the flags typically do not appear until after search results have been provided to the mobile device 202.

FIG. 3 illustrates example results 300 that may be determined to be relevant based upon the query 204 for ice cream. In the illustrated embodiment, the results are displayed in a table, with respective results being represented in a row of the table, although other data arrangements are also contemplated. The illustrated table further comprises a column 302 for distance and a column 304 representing store hours of respective shops. The distance column 302 is indicative of a (shortest) travel route between a location of the user and the shop, although it may be indicative of other possible travel routes. Moreover, in one embodiment, the table or other data arrangement may further comprise a column 306 indicative of an estimate time of arrival to respective shops based upon the user's location.

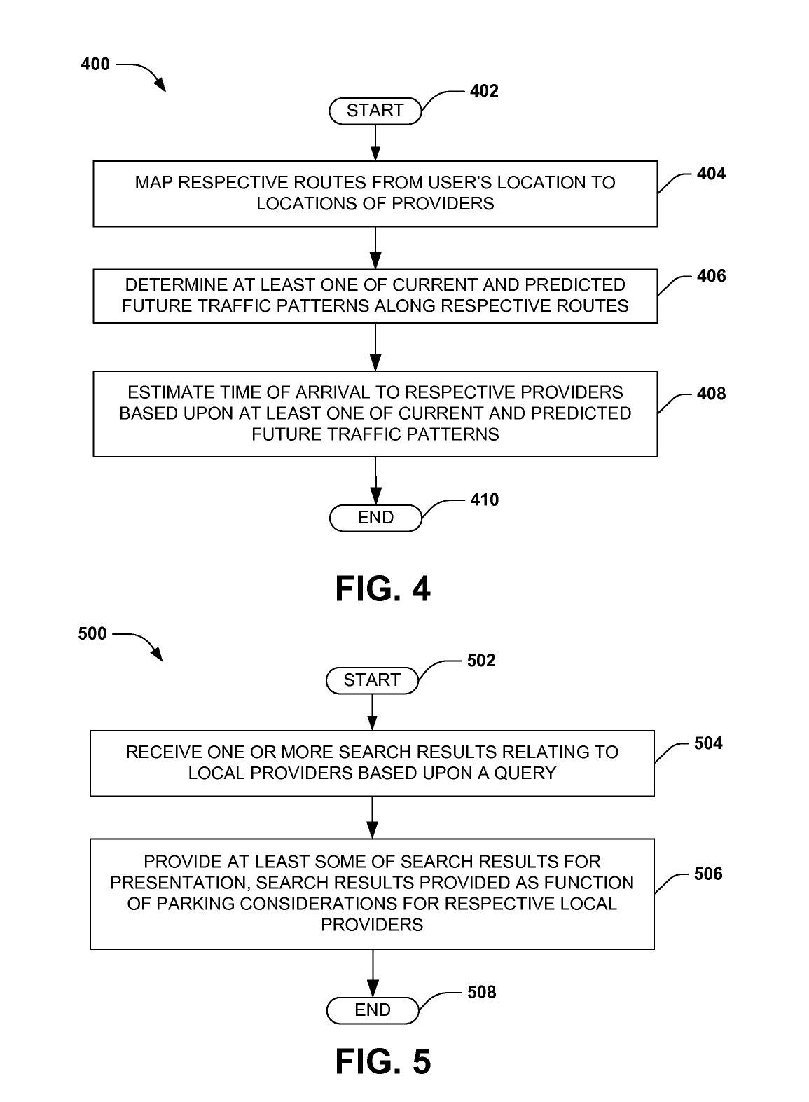

It will be appreciated that at least some of the data represented in the example table may be optional and/or may be a function of how results are filtered, for example. As an example, where results are filtered/distinguished based upon availability as determined at the time of the search, the table may merely list store hours of respective shops. Conversely, where availability is a function of an estimated time of arrival to respective shops, the ETA may be calculated for respective shops (e.g., using example method 400 illustrated in FIG. 4) and comprised in the table, for example.

As described with respect to the example method 100 of FIG. 1, the search results that are provided for presentation may be a function of whether one or more providers are available at the time the search is performed. For example, if the search is performed at 10:30 pm and Tom's Shop closes at 10 pm, Tom's Shop may be determined to be unavailable. Therefore, while Tom's Shop may be relevant because it is at least one of temporally and/or geographically proximate the user and/or satisfies the search, it may not be provided for presentation because it unavailable at the time of the search. Alternatively, it may be provided for presentation, but may be distinguished from other search results that are available, for example. The other relevant search results are associated with stores that are open past 10:30 pm, and may therefore be considered available if availability is merely dependent upon whether respective providers are opened at the time of the search.

In another embodiment of the example method 100 of FIG. 1, the availability/unavailability of a provider may not be (merely) dependent upon whether the provider is available at the time of the search, but may also/instead be dependent upon whether the provider is expected to be available at an estimated time of arrival to respective providers. That is, as illustrated in the example method 400 of FIG. 4 (e.g., described below), the estimated time of arrival to respective providers from the user's present location (e.g., at the time of the search) may be calculated and used to assist in determining whether respective providers are expected to be open by the time a user could travel to the provider.

By way of example, the column 306 labeled ETA provides for an estimated time of arrival (ETA) to respective providers from the user's determined location. Such an ETA may be determined as a function of a shortest route, a fastest route, and/or other route considerations (e.g., such as avoiding toll roads and/or avoiding highways). Moreover, as will be described in more detail below, the ETA may take into consider actual and/or predicted current traffic patterns and/or predicted future traffic patterns (e.g., based upon time of day, historic trends for roads along respective routes, weather conditions, road construction, etc.). As one example, respective ETAs may represent an approximation of the earliest a user could arrive at the location after current and future traffic patterns are taken into consideration.

As illustrated in FIG. 3, the user should have little to no problem arriving at Ice Cream Bonanza and/or Summer Chill before respective shops close. However, the user is not expected to arrive at Sweet Treats until 10:46 pm, which is after the 10:45 pm closing. Therefore, the provided search results may merely comprise Ice Cream Bonanza and Summer Chill since Tom's Shop was unavailable at the time of the search (and remains unavailable at the estimated time of arrival to Tom's Shop) and Sweet Treats is expected to be unavailable by the time the user arrives there. Alternatively, in another embodiment, Tom's Shop and/or Sweet Treats may be provided in the presented search results, but may be distinguished from the other results because of their predicted unavailability.

Returning to FIG. 2, once relevant results have been identified from the received information 204 (e.g., the query and location information) and/or the results have been filtered/distinguished based upon provider availability, the results 210 may be provided to the mobile device 202 and/or other device associated with the user via the one or more network interfaces 208, for example. In this illustrated embodiment, the provided search results 210 distinguish those providers that are expected to be available from those that are unavailable and/or expected to be unavailable at an estimated time of arrival (e.g., as opposed to filtering the unavailable providers from the provided search results 210). For example, providers that are unavailable may are indicated as such via a square flag, providers that are expected to be unavailable at an ETA are indicated as such via a circular flag, and providers that are expected to be available at an ETA are indicated as such via a triangular flag.

It will be appreciated that such differentiation illustrates merely one technique for distinguishing available providers from other available providers, and other techniques/differentiation styles are also contemplated. Moreover, in other embodiments, providers may be categorized into different categories. For example, whereas the provided search results 210 categorize providers into three categories: unavailable, expected to be unavailable at ETA; and expected to be available at ETA, the provided search results 210 may be categorized differently. For example, in another embodiment, shops that close shortly before and/or after a user's ETA may be distinguished from other providers (e.g., to provide caution to the user about visiting these providers).

As further illustrated by FIG. 2, the provided search results 210 may be presented to the user via the mobile device 202 and/or other device. For example, in the illustrated example, flags representing respective providers are overlaid on the map, where the position of respective flags on the map is indicative of the location of the provider to which the flag is associated. In one embodiment, a user may select one or more of the flags to be provided additional information about respective locations represented by the flags (e.g., such as store hours, address, phone number, etc.).

FIG. 4 illustrates an example method for calculating an estimated time of arrival (ETA) to respective providers. The example method 400 begins at 402, and one or more routes from the user's location to respective locations of providers identified in the search results may be mapped at 404. The routes may be a function of the user's intended/specified mode of transportation. For example, different routes may be identified/mapped when the user is riding a bike and/or walking versus when the user is driving a car. Moreover, the time it takes to travel 1 mile may vary significantly according to the mode of transportation. Thus, the search query (e.g., 204 in FIG. 1) received at 104 in the example method 100 of FIG. 1 may specify an intended mode of transportation, for example.

At 406 in the example method 400, at least one of current and/or future traffic patterns along respective routes are determined. Determining current traffic may comprise, among other things, receiving information from traffic services configured to, among other things measure traffic/pedestrian congestion and/or identify roads/sidewalks closed due to construction. Determining current traffic may also comprise predicting current traffic patterns (e.g., using historical traffic patterns for roads along the route, available weather information, available construction information, etc.). Similarly, determining future traffic patterns (e.g., indicative of the predicted traffic at the time the user travels that route) may be based at least in part upon, among other things, current traffic patterns, time of day, historical information, and/or weather conditions, for example.

At 408 in the example method 400, a time of arrival to respective providers from the user's location is estimated based upon the traffic patterns along respective routes. As described with respect to FIGS. 2-3, such ETAs may be useful for determining whether a provider is expected to be opened when a user arrives at the provider's location, for example. By way of example, a store that is closed at the time of a search may be opened (e.g., and thus by available) by the time a user could travel to the store. Conversely, a store that is open at the time of the search may close (e.g., and thus be unavailable) before a user could make it to the store.

It will be appreciated that while the example method 400 describes the acts of mapping respective routes, determining traffic patterns along respective routes, and estimating arrival times as being successive acts, in one embodiment, the acts may be performed currently and/or in concert with one another. By way of example, generating a route may be an iterative process, whereby a route having a shortest distance and/or a route with the earliest ETA is initially generated and traffic patterns for roads along the route are determined/predicted. If the determined/predicted traffic patterns indicate that one or more roads/pathways along the route are experiencing delays, a second route may be generated and traffic patterns for roads/pathways along the second route may be determined/predicted. Such a process may be repeated until a satisfactory route is generated (e.g., until a route is generated with a shortest amount of travel time)

The example method 400 ends at 410.

While the FIG. 4 provides for taking into consideration current and/or future traffic patterns when estimating a time of arrival to respective providers, in some embodiments, the ETA may be estimated in other (more simplistic) manners known to those skilled in the art. For example, in another embodiment, the ETA to respective providers may be based merely upon the speed limit of respective roads along a route from the user's location to the provider. Thus, numerous techniques are known for calculating an ETA and are contemplated for use herein.

Moreover, while FIGS. 2-4 describe techniques for determining the availability of a provider as a function of, among other things, hours of operation for respective providers, other considerations are also/instead contemplated to determine availability of respective providers. For example, determining whether one or more providers are available may be based upon parking considerations for respective providers.

FIG. 5 illustrates an example method 500 providing search results for presentation as a function of parking considerations. Such parking considerations may comprise, among other things, the availability of parking (e.g., number of parking spaces available), the type of parking available (e.g., on-site, on-street, etc.), and/or the cost of available parking. Whether parking considerations are considered in the availability of a provider and/or the types of parking considerations that are considered may be specified by default and/or may be specified by a user. For example, a user may be unable to parallel park a vehicle, so s/he may request search results that merely comprise providers with on-site parking. Therefore, the user may define availability based upon parking considerations (e.g., such that providers that providers that would otherwise be available are considered unavailable based upon how the user defines availability) and/or availability may be determined by default (e.g., which can be subsequently modified by the user).

The example method 500 begins at 502 and one or more search results relating to local providers are received at 504 based upon a received query. That is, as described with respect to example 100 of FIG. 1, a query is received and a location of a user for whom the query is performed is determined. Based upon the query and/or the location of the user, relevant search results are identified. Generally, these search results comprise one or more providers that are at least one of temporally and/or geographically proximate the location of the user (e.g., and thus may be referred to as local providers). It will be appreciated that while reference is made herein to the providers being local, as described above, local may be a relative term that fluctuates based upon the query that is performed. For example, if the query pertains to a company that does not have locations within 20 miles, the local providers that are comprised in the search results maybe 20 or more miles away.

At 506 in the example method 500, at least some of the search results are provided for presentation. That is, at least some of the search results are sent to the device from a remote computing system performing the search and/or are otherwise provided for display on a device associated with the user.

The search results provided at 506 may be a function of parking considerations at respective local providers identified in the search results. For example, among other things, parking information from parking garages spatially neighboring the local providers, parking information from the providers themselves, and/or parking information from customers of respective providers may be acquired and used to determine the availability of respective providers. Similarly, the time of day when the search is performed and/or when a user is expected to arrive at a provider may be utilized to assist in determining the availability of respective providers. For example, it may be predicted that during the morning rush hour, coffee houses tend to have limited to no available parking because people tend to get coffee on their way to work.

Other parking considerations that may be relevant to determining available parking include, among other things, the type of parking and/or the cost of parking. For example, providers with on-site parking may be distinguished from providers that merely offer on-street parking (e.g., where parking spots are often more difficult to find, making the provider less available). Moreover, the parking rates of a provider's parking lot(s) and/or neighboring parking lots/garages may be considered in determining available. For example, if two coffee houses are substantially equidistant from a user's location, but it would cost 5 dollars to park near one of the coffee houses, while parking at the other coffee house is free, the provided search results may differentiate the coffee house with free parking from the coffee house with 5 dollar parking.

It will be understood from the preceding paragraph that availability isn't necessarily black-or-white. That is, availability may be a function of, among other things, the identified providers that satisfy the query, a degree to which parking is available for respective providers, and/or a relative cost of parking. For example, suppose a user is searching for parking within a 1 mile radius of a professional football game. If availability was defined to mean providers with free parking, no providers may be located. However, if availability is defined to mean providers with cheaper parking relative to other providers (e.g., garages) in the one mile radius, those garages with the cheapest parking may be considered available. Thus, availability may be dynamically adjusted as a function of the providers identified from the query (e.g., to find the provider(s) that are likely to be most available and/or best suited to match a user's desires (e.g., for cheap parking, on-site parking, etc.))

The example method 500 ends at 508.

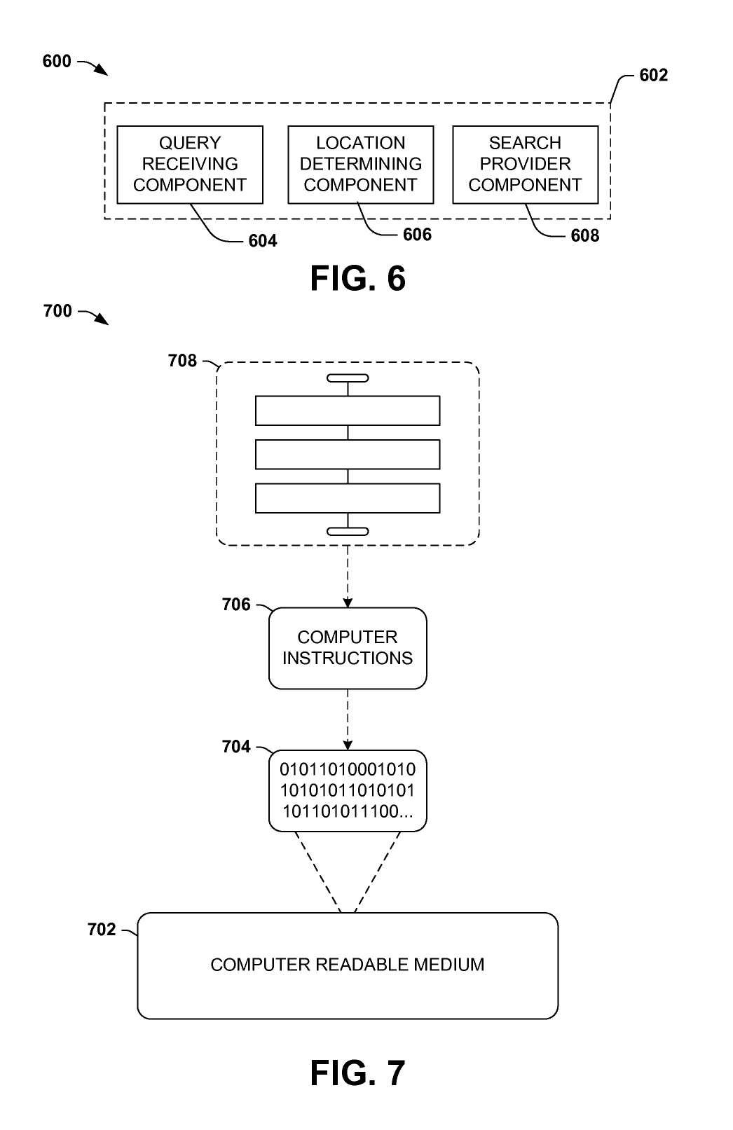

FIG. 6 illustrates an exemplary environment 600 of an example system 602 (e.g., 208 in FIG. 2) for providing search results as a function of the availability of one or more providers, such as goods providers and/or service providers, for example. That is, stated differently FIG. 6 illustrates an example system 602 for processing a request for one or more providers and for providing, in response to the request, one or more search results indicative of providers, where providers are distinguished and/or filtered based upon the availability of respective providers. As described above, such availability may be a function of, among other things, the time of day when the request is received, store hours of respective providers, an amount of time it would take a user to arrive at respective providers, and/or parking considerations.

The example system 602 comprises a query receiving component 604, a location determining component 606, and a search provider component 608. The query receiving component 604 is configured to receive a query comprising one or more search terms. Such a query may be auto-generated and/or may be generated at the requested of a user, for example.

The example system 602 further comprises a location determining component 606 configured to determine a location of a user performing the query and/or to determine a location of a device associated with the user. That is, stated differently, location information may be acquired from a device associated with a user performing the query and may be used to determine/identify a location of the user or a device associated with the user. For example, the device may comprise a GPS component, wireless receiver, and/or other signal detection component configured to detect signals/data that can be utilized (e.g., by the location determining component 606) to determine a location of the user.

By way of example, in one embodiment, a user may be attempting to locate law offices within at least one of a temporal and a geographic proximity of the user. The user may open an application on his/her mobile phone, tablet, computer and/or other electronic device and perform a search for nearby law offices, which may be received by the query receiving component 604. Moreover, the device may acquire information from which the device's location can be determined and the location determining component 606 can be configured to use such information to determine a location of the device and/or a user associated with the device.

Based upon the query and the determined location of the user, the example system 602 may be configured to identify relevant results. Typically, such results are indicative of one or more providers that are within at least one of a temporal and a geographic proximity of the determined location. For example, the identified results may comprise the names/locations of law offices within a 10 mile radius of the user.

The example system 602 also comprises a search provider component 608 configured to provide, for presentation on the device associated with the user, one or more of the identified results. Generally, at least some of the provided search results are at least one of filtered and/or distinguished by the search provider component 608 based upon their respective availability. For example, as described in detail above, the search provider component 608 may be configured to filter one or more of the identified results and/or distinguish at least some of the identified results from other identified results based upon, among other things, the store hours of respective providers, parking considerations of respective providers, and/or whether providers are likely to be open by a time the user arrives at the provider (e.g., presuming the user begins to travel to the provider shortly after the search). Because such considerations are described in detail above and for purposes of brevity, it will be appreciated that such considerations are not rehashed with respect to the search provider component 608 and/or the system 602. Thus, it may be sufficient to merely note the search provider component 608 is configured to filter and/or distinguish results as described in detail with respect to FIGS. 1-5.

Moreover, while the example system 602 is merely described with respect to three components, it will be appreciated that the system 602 may further comprise other components, some of which may be a function of how availability is defined. For example, where availability is a function of store hours, the example system 602 may further comprises a provider component configured to determine when respective providers, comprised in the identified results, are at least one of open and/or closed. As another example, where availability is a function of whether a user could arrive at the location while it is opened (e.g., and thus available), the system 602 may further comprise a route generator configured to generate one or more routes from the determined location of the user (e.g., as determined by the location determining component 606) to respective providers and/or to estimate a time of arrival to respective providers based upon the determined location of the user. As yet another example, where availability is a function of one or more parking considerations, the example system 602 may comprise a parking component configured to, among other things, determine/predict parking availability, parking routes, and/or types of parking for respective providers.

Thus, the example system 602 is merely intended to describe one example of a system for providing search results for presentation based upon the availability of respective providers comprised in search results and is not intended to be viewed as necessarily limiting the scope of the disclosure, including the scope of the claims. Moreover, the types of components comprised in a system may be a function the premise(s) for determining availability, and thus components may be changed, added, and/or subtracted from the system according to how availability is defined.

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 702 (e.g., a CD-R, DVD-R, or a platter of a hard disk drive), on which is encoded computer-readable data 704. This computer-readable data 704 in turn comprises a set of computer instructions 706 configured to operate according to one or more of the principles set forth herein. In one such embodiment 700, the processor-executable computer instructions 706 may be configured to perform a method 710, such as at least some of the exemplary method 100 of FIG. 1, 400 of FIG. 4, and/or 500 of FIG. 5, for example. In another such embodiment, the processor-executable instructions 706 may be configured to implement a system, such as at least some of the exemplary system 600 of FIG. 6, for example. Many such computer-readable media 702 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

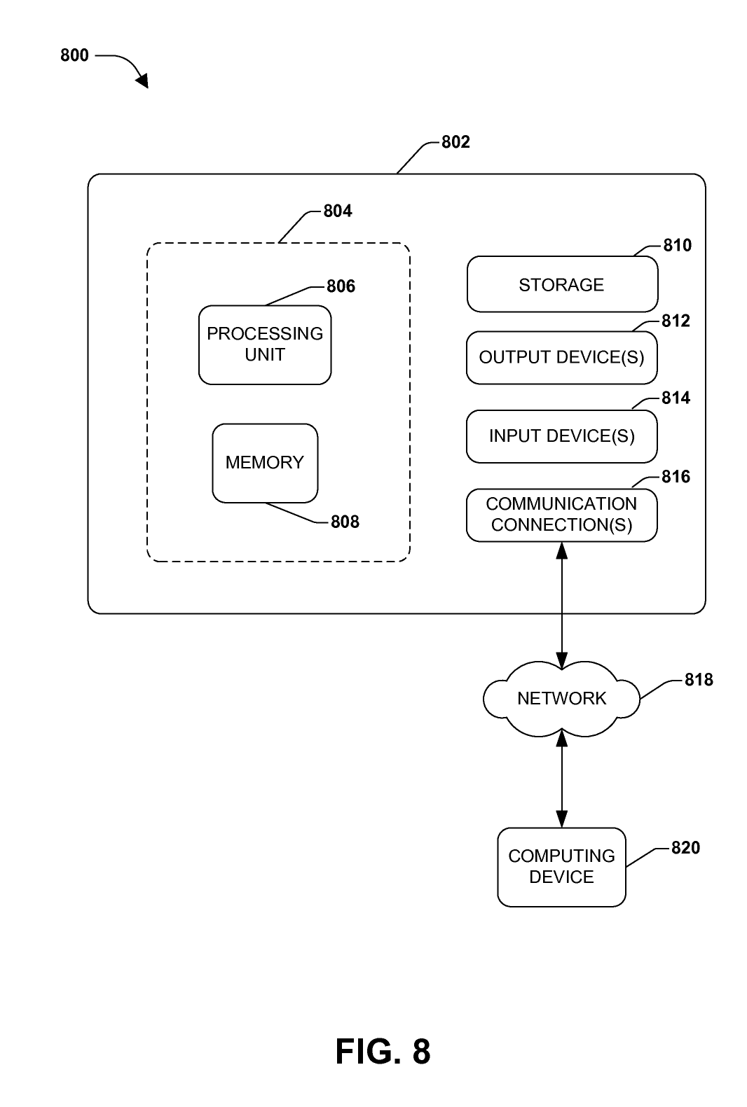

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 618 may be volatile (such as RAM, for example), non-volatile (such as ROM, flash memory, etc., for example), or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 6 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via a network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based at least in part upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for providing one or more search results comprising:
receiving a query;
determining a location of a user performing the query; and
providing one or more search results for presentation based upon the query, the search results indicative of one or more providers within at least one of a temporal and a geographic proximity of the location, and the search results provided as a function of whether the one or more providers are available.

2. The method of claim 1, comprising determining whether the one or more providers are available based upon whether respective providers are open or closed when the search results are being provided for presentation.

3. The method of claim 2, providing the one or more search results for presentation comprising distinguishing one or more providers are open from one or more providers that are closed.

4. The method of claim 1, comprising estimating a time of arrival to respective providers based upon the determined location of the user and respective locations of the providers.

5. The method of claim 3, comprising determining whether the one or more providers are available based upon whether respective providers are expected to be opened or expected to be closed at the estimated time of arrival to the respective providers.

6. The method of claim 5, providing the one or more search results for presentation comprising distinguishing one or more providers that are expected to be open at the estimated time of arrival from one or more providers that are expected to be closed at the estimated time of arrival.

7. The method of claim 4, estimating the time of arrival to respective providers comprising:
mapping respective routes from the determined location of the user to respective locations of the providers;
determining at least one of current and predicted future traffic patterns along respective routes; and
estimating the time of arrival to respective providers based upon at least one of the current and predicted future traffic patterns.

8. The method of claim 7, comprising determining whether the one or more providers are available based upon whether respective providers are expected to be opened or expected to be closed at the estimated time of arrival given at least one of the current and predicted future traffic patterns.

9. The method of claim 1, providing the one or more search results for presentation comprising distinguishing one or more providers that are at least one of open and expected to be open at an estimated time of arrival for the user.

10. The method of claim 1, comprising determining whether the one or more providers are available based upon parking considerations at respective providers.

11. The method of claim 10, the parking considerations comprising at least one of:
availability of parking;
type of parking; and
monetary cost associated with parking.

12. The method of claim 1, providing the one or more search results for presentation comprising providing the one or more search results for presentation on a mobile device.

13. A system, comprising
a query receiving component configured to receive a query;
a location determining component configured to determine a location of a user performing the query; and
a search provider component configured to provide one or more search results for presentation based upon the query, the search results indicative of one or more providers within at least one of a temporal and a geographic proximity of the location, and the search results provided as a function of whether the one or more providers are available.

14. The system of claim 13, comprising a provider component configured determine times when respective providers are at least one of open and closed, and the search provider component configured to determine whether the one or more providers are available based upon whether respective providers are open or closed when the search results are being provided for presentation.

15. The system of claim 13, comprising a route generator component configured to generate respective routes from the determined location of the user to respective locations of the providers and to estimate a time of arrival to respective providers based upon the respective routes.

16. The system of claim 15, comprising a provider component configured determine times when respective providers are at least one of open and closed, and the search provider component configured to determine whether the one or more providers are available based upon whether respective providers are expected to be open at the estimated time of arrival.

17. The system of claim 15, the estimated time of arrival to respective providers taking into consideration at least one of current traffic conditions and predicted future traffic conditions along the respective routes.

18. A computer readable medium comprising computer executable instructions that when executed via a processor perform a method comprising:
receiving one or more search results relating to local providers based upon a query; and
providing at least some of the search results for presentation, the search results provided as a function of parking considerations of respective local providers.

19. The computer readable medium of claim 18, providing the at least some of the search results comprising distinguishing local providers having on-site parking from local providers having merely on-street parking.

20. The computer readable medium of claim 18, the method comprising at least one of:
determining parking availability of respective local providers, and providing at least some of the search results as a function of the determined parking availability, and
predicting parking availability of respective local providers, and providing at least some of the search results as a function of the predicted parking availability.

21. The computer readable medium of claim 18, the method comprising determining parking cost associated with visiting respective local providers, and providing at least some of the search results as a function of determined parking cost.
